(19) United States
(12) Patent Application Publication
(10) Pub. No.: US 2026/0331451 A1
(43) Pub. Date: Oct. 22, 2026

(54) METHOD OF ION SCHEDULING

(71) Applicants: Thermo Fisher Scientific (Bremen) GmbH, Bremen (DE); Thermo Finnigan LLC, San Jose, CA (US)

(72) Inventors: Hamish Stewart, Bremen (DE); Alexander Makarov, Bremen (DE); Michael W. Senko, Sunnyvale, CA (US); Graeme McAlister, San Jose, CA (US); Mikhail V. Ugarov, San Jose, CA (US); Denis Chernyshev, Bremen (DE); Michael Goodwin, Santa Clara, CA (US)

(21) Appl. No.: 19/638,145

(22) Filed: Apr. 3, 2026

Related U.S. Application Data
(60) Provisional application No. 63/782,859, filed on Apr. 3, 2025.

(51) Int. Cl. H01J 49/42; H01J 49/00; H01J 49/40

(52) U.S. Cl. CPC H01J 49/427; H01J 49/0031; H01J 49/40; H01J 49/4215

(57) ABSTRACT

A method of scheduling ions for analysis is provided. The method comprises performing a plurality of ion scheduling cycles. Each ion scheduling cycle comprises an ion scheduling device receiving ions, wherein the ion scheduling device separates the ions into a plurality of groups of ions according to their m/z or ion mobility and outputs the plurality of groups sequentially to an ion selection device. For each group of ions received by the ion selection device, the ion selection device selects a subset of ions from the group and outputs the subset of ions for analysis. For each of the plurality of ion scheduling cycles, the ion selection device selects different subsets of ions from the plurality of groups of ions.

### CROSS REFERENCE TO RELATED APPLICATION

This patent application claims the benefit of priority to United States Provisional Patent Application Ser. No. 63/782,859, filed on Apr. 3, 2025, which is hereby incorporated by reference herein in its entirety.

### FIELD OF THE DISCLOSURE

The present disclosure relates to mass spectrometry. In particular, the present disclosure relates to a method of ion scheduling.

### BACKGROUND

US-A-2939952 discloses a tandem mass spectrometer which employs a quadrupole mass filter to isolate target ions prior to fragmentation and further downstream mass analysis. One feature of the quadrupole mass filter is that unselected ions strike the quadrupole rods of the quadrupole mass filter, losing precious analyte ions whilst also contaminating and eventually degrading the electrodes. Depending on the isolation windows employed, the loss of theoretical sensitivity may easily exceed 99%.

One workaround is to accumulate and separate ions in advance (upstream) of the quadrupole, so that the ion m/z delivered to the device approximately matches the range of the isolation window and ion losses are consequently minimized to the accuracy of the pre-separation. Residual losses then become a factor of the resolution of the pre-separation and the quality of the alignment to the quadrupole isolation window.

The method was first described by Hoyes in GB-A-2442638, whereby ions were first loaded into an ion trap. An RF pseudopotential barrier would prevent release of ions of higher m/z, unless overcome by a DC or travelling wave pushing them towards to exit, whereupon they would be released for quadrupole selection/fragmentation etc. Giles in US-B-6914241B and Bateman US-B-6838662 further describe a method of using an opposed travelling wave and non-linear DC gradients to cause separation of ions within a guide. These reach equilibrium positions and may, by adjusting the DC or travelling wave amplitude, then be released in a time dependent manner through a quadrupole, greatly boosting its efficiency. FIG. 1 illustrates ion separation under these two opposing forces, while FIG. 2 shows a schematic diagram of an ion scheduling method using an ion scheduling device and a quadrupole.

There are multiple technologies that may be used to achieve this “ion scheduling” process. Typical methods involve separating ions under the exposure of two different forces, such as DC potential, RF pseudopotential (or travelling wave), or collisional drag with buffer gas. A method of ion scheduling comprising parallel acquisition of ions followed by serial fragmentation is discloses in US-B-10665441. A parallel accumulation and serial fragmentation method from a trapped ion mobility spectrometry (TIMS) device is also disclosed in Meier, F. et al. Parallel Accumulation-Serial Fragmentation (PASEF): Multiplying Sequencing Speed and Sensitivity by Synchronized Scans in a Trapped Ion Mobility Device. Journal of Proteome Research 2015, 12, 5378-5387, US-B9891194 and US-B-10794861). Other implementations include accumulation into multiple traps, either orthogonally across an RF pseudopotential (US-B-10199208) or via ion mobility (US-B-9607817).

It is also known to utilise travelling waves to propel ions through ion guides. US-B-7375344 discloses the application of a series of out-of-phase RF potentials, while Giles et al, Applications of a travelling wave-based radio-frequency-only stacked ring ion guide, Rapid Commun. Mass Spectrom. 2004; 18:2401-2414, discloses the application of switched DC pulses to successive axial segments of an ion guide to create a potential front that moves down the centre of the guide with time, dragging ions with it.

Mass spectrometers control ion loading to trapping devices by varying ion accumulation time, in a process known as Automatic Gain Control (AGC). Ion scheduling devices necessarily block this process by transforming a continuous ion beam into time-varying, concentrated pulses of ions of similar m/z. It is believed that this issue may be resolved by a downstream beam attenuating device, most promisingly by varying the duty cycle of a rapidly pulsed ion optical gating element. US-B-7960690 has demonstrated this effect with 1 kHz switching, where ion packets are expected to emerge with <2 ms pulse width.

Tandem mass spectrometry methods involve the isolation and fragmentation of eluted analyte species, whereby fragment mass spectra are then generated and mass analysed to return structural and quantitative information. These MS/MS, or MS2 spectra are often supported by survey analyses of a wide range of unfragmented precursor ions, termed MS1, MS or Full-MS analyses, that provide information on their accurate m/z and intensity. For Data Independent Acquisition (DIA) methods, this analysis is optional, but for Data Dependent Acquisition (DDA), it is required to generate a list of precursor targets for MS2 analysis. A substantial problem is posed by the dynamic range of the MS1 spectrum. Digested peptide concentration varies by up to 10 orders of magnitude, but the dynamic range of a single shot spectrum in, for example, an orbital trapping mass analyser is limited to 4. Furthermore, the number of ions that may be injected into an orbital trapping mass analyser is limited by the capacity of the accumulating C-Trap to ~10⁵, and consequently low intensity peptide precursor signals are easily overwhelmed and potential targets for fragmentation missed or poorly quantified.

One important method to improve the dynamic range of the MS1 spectrum is the High Dynamic Range (HDR), or Boxcar method, whereby the wide m/z range of interest for the analysis is subdivided into a number of narrower isolation windows, and a separate injection made into the C-Trap for each, with differing fill time dependent on the ion current (Meier et al, Nature Methods, 2018, 15, 440-448). The total ion population is then analysed together, for example in an orbital trapping mass analyser. By this method heavily populated regions are attenuated and sparsely populated mass regions amplified, boosting many relatively weak peaks and greatly improving the effective dynamic range of the scan. This comes at the cost of greatly increasing the time required to accumulate ions over multiple fills. Because of the long fill times for low-level windows, and the milliseconds required to switch the quadrupole and ion source voltages, HDR analyses quickly impacts the rate at which MS2 scans that may be made.

Against this background, the present disclosure provides an improved, or at least commercially relevant alternative method of scheduling ions for analysis is provided.

### SUMMARY

According to a first aspect of the disclosure, a method of scheduling ions for analysis is provided. The method comprises performing a plurality of ion scheduling cycles. Each ion scheduling cycle comprises an ion scheduling device receiving ions, wherein the ion scheduling device separates the ions into a plurality of groups of ions according to their m/z or ion mobility and outputs the plurality of groups sequentially to an ion selection device. For each group of ions received by the ion selection device, the ion selection device selects a subset of ions from the group and outputs the subset of ions for analysis. For each of the plurality of ion scheduling cycles, a deviation of the ion scheduling device is varied such that the plurality groups of ions span a different m/z range or ion mobility range. For each ion scheduling cycle, the ion selection device selects different subsets of ions from the plurality of groups of ions.

The interaction of ion scheduling with fast (200-400 Hz) spectral acquisition, fast switching between MS1 and MS2 analyses, and control of the ion population of space charge limited downstream trapping regions (e.g. via automatic gain control) have emerged as considerable technological challenges. This method of the first aspect provides a method of scheduling ions which enables MS1 and MS2 analyses to be combined with other auxiliary analyses (e.g. AGC analyses and the like) for as part of a DDA or DIA method of mass spectrometry for example.

Ion scheduling devices typically have a limited resolution for separating ions into groups. In particular, an ion scheduling device may have a lower resolution than the downstream ion selection device (e.g. a quadrupole mass filter). As it may not be possible for the ion selection device to isolate every ion species of interest released from the ion scheduling device in a single group or single cycle, the method of the first aspect utilises the ion selection device to select a subset of ions from each group of ions output by the ion scheduling device. Over a plurality of ion scheduling cycles, the ion selection device selects different subsets of ions from the plurality of groups of ions such that all ion species of interest can be output for analysis. It will be appreciated that as each subset of ions is selected from a group of ions having a narrower m/z range or narrower ion mobility range than the full ion population, relatively intense ion species may be excluded from the groups of ions/subsets of ions. Accordingly, the dynamic range of the subsets of ions output for analysis may be improved according to the method of the first aspect.

For each of the plurality of ion scheduling cycles, a deviation of the ion scheduling device is varied such that the plurality groups of ions span a different m/z range or ion mobility range. It will be appreciated that the ion precursors at the fringes of each group of ions output by the ion scheduling device may suffer from transmission losses. By varying the m/z range or ion mobility range of the ion scheduling device between each ion scheduling cycle, the ion precursors at the fringes of each group vary between cycles. Thus, the effect of transmission losses may be reduced or eliminated across the plurality of ion scheduling cycles.

In some embodiments, the groups of ions output by the ion selection device may be mass analysed using a mass analyser or analysed using ion mobility spectrometry. The number of groups of ions analysed per cycle of the ion scheduling device may depend on a resolution of the ion scheduling device, as well as the ion capacity of the ion scheduling device. For example, if the mass resolving power covers 10% of the range, then it makes sense that only 10 groups of ions may be output and subsequently mass analysed, (assuming that none of the desired target windows overlap with one another.

In some embodiments, the method of mass spectrometry may be utilised to provide ion groups for a DIA (data independent acquisition) mass analysis methodology. For example, for a m/z range of interest of 100-1000 m/z, the ion scheduling device may make stepped extractions of 100-200, 200-300 . . . 900-1000 m/z (i.e. the ion scheduling device separates the ion into groups of ions each having a width of about 100 Th). A mass selection device (e.g. a quadrupole mass filter) may then mass select each group of ions to output a narrower range (e.g. 10 m/z) subset of ions suitable for a DIA analysis. It will be appreciated that the mass selection device may not be able to output subsets of ions sequentially (e.g. 100-110, 110-120, 120-130 m/z etc.). Rather, the mass selection device may take a single shot from each group of ions output per ion scheduling cycle: e.g. 100-110, 200-210 . . . 900-910 m/z then e.g. 110-120, 210-220 . . . 910-920 m/z in the next cycle, and so on until all DIA windows are measured. If each ion scheduling cycle may be completed in ~100 ms, similar to a TIMS device, then the full DIA methodology across the m/z range of interest would take about one second.

In some embodiments, for each group of ions, the ion selection device may output a subset of ions having a m/z range or an ion mobility range which is centred about a central m/z or central ion mobility of the respective group of ions. By selecting ions from a central range of each group of ions, the effect of transmission losses on the selected ions may be reduced. In some embodiments, the deviation of the ion scheduling device (and the associated deviation of the m/z range or ion mobility range of each group of ions) may be controlled by a shift in the applied timings of ion scheduling device and/or a shift in a voltage applied to the ion scheduling device for separating the ions.

For example, the ion scheduling device may separate ions into a plurality of groups according to their m/z, each group having a first m/z window width. The first m/z window width may be at least 50 Th, though narrower m/z windows (e.g. at least: 10 m/z, 20 m/z, 30 m/z, or 40 m/z) may be achieved by higher resolution ion scheduling devices. The first m/z window width may be no greater than about: 200 Th, 150 Th, 100 Th or 50 Th. Each group may have an associated m/z range. For example, in some embodiments, each first m/z window width may have an m/z range of between 45 m/z to 80 m/z. For example, for a m/z range of interest of 400 m/z to 1000 m/z and a first m/z window width of 200 Th, the plurality of groups may have m/z ranges of 400-600, 600-800, and 800-1000 m/z.

The ion selection device may select a subset of ions from each group having a second m/z window width, wherein the second m/z window width is less than the first m/z window width. For example, the second m/z window width may be no greater than about: 20 Th, 15 Th, 10 Th, 5 Th, or 2 Th. Accordingly, the mass selection device may produce subsets of ions having relatively narrow m/z ranges for analysis from the groups of ions output by the ion scheduling device. In some embodiments, the mass selector device outputs each subset of ions having a different m/z range such that across the plurality of ion scheduling cycles the subsets of ions output cover a m/z range of interest.

In some embodiments, the ion scheduling device may output the groups of ions to the ion selection device in order of increasing m/z or increasing ion mobility. In some embodiments, the ion scheduling device may output the groups of ions to the ion selection device in order of decreasing m/z or decreasing ion mobility. The order in which the groups of ions are output by the ion scheduling device may depend on the design of the ion scheduling device. In some embodiments, the order in which the ions may be output may be adjusted in order to prioritise the analysis of ions of a relatively high m/z or ion mobility, or to prioritise the analysis of ions of a relatively low m/z or ion mobility accordingly.

The ion scheduling device according to this disclosure may be implemented in various manners. In general, ion scheduling devices according to this disclosure separate ions into a plurality of groups of ions according to their m/z or ion mobility and output the plurality of groups sequentially. In some embodiments, the groups of ions output may each be elongated along an axial direction of the ion scheduling device. By outputting ion groups which are elongated along an axial direction, the space charge capacity of each group may be relatively high.

In some embodiments, the ion scheduling device may comprise a linear ion guide. As such, the ion scheduling device may separate the ions into a plurality of groups of ions by application of a travelling wave potential along the linear ion guide. Use of a travelling wave to separate the ions allows the ions to be separated into groups with minimal ion losses and in a timescale which is compatible with relatively high-speed DIA methodologies.

In some embodiments, the ion scheduling device comprises a bypass region configured to allow ions to bypass the ion scheduling device to the ion selection device. In some embodiments, the bypass region may be a bypass ion guide provided in parallel with the linear ion guide. In some embodiments, the ion scheduling device may comprise an ion scheduling region and a bypass region. The bypass region may be configured to receive ions and to transfer ions to the ion scheduling region or to output ions to the ion selection device. The ion scheduling regions may then separate the ions into groups, wherein the separated groups are each transferred to the bypass region and output to the ion selection device. For example, such an ion scheduling device may have a generally T-shaped arrangement. By providing a bypass region, packets of ions may be transferred directly to the mass selection device concurrently with the scheduling of ions via the ion scheduling device. Accordingly, in some embodiments analyses of ions which have not been separated into an ion group (via the ion scheduling device) may be interleaved with the ion groups output to mass selecting device. This may enable the performance of survey mass analyses (i.e. an MS1 analysis across the mass range of interest), mixing of internal calibrant or reagent ions into analyses, or targeted analyses of specified precursor ions to be scheduled during the operation of the ion scheduling device. For example, in some embodiments where more than one ion source is provided (e.g. first and second ion sources are provided), ions output from the second ion source such as internal calibrant ions may be transferred towards the mass analyser via the bypass region. The ions output from the second ion source may then be interleaved or mixed with the ion groups output to mass selecting device from the ion scheduling device. As such, the provision of an ion scheduling device provides increased flexibility for additional analyses to be interleaved with the ions being scheduled for analysis via the ion scheduling device.

For example, in some embodiments the method may comprise scheduling a survey group of ions for analysis during the plurality of ion scheduling cycles, wherein the survey group of ions is output to the ion selection device via the bypass ion guide of the ion scheduling device. In some embodiments, the method may comprise scheduling a targeted precursor ion for analysis, wherein the targeted precursor ion is output to the ion selection device via the bypass ion guide (along with other ions in the mass range of interest), wherein the ion selection device filters out other ions from the mass range of interest and outputs the targeted precursor ion for analysis.

In some embodiments, the ion scheduling device may be a multi-trap ion scheduling device. The (multi-trap) ion scheduling device may comprise plurality of ion traps, wherein each ion trap is associated with a different m/z range or a different ion mobility range. The admission and/or extraction of ions from plurality of ion traps may be controlled in order to separate the ions into the plurality of groups according to their m/z or ion mobility. As such, the ion scheduling device may separate the ions into the plurality of ion traps in parallel. The groups of ions may then be output sequentially from the ion traps to the ion selection device.

In some embodiments, the method of ion scheduling of the first aspect may be provided as part of a Data Independent Acquisition (DIA) mass spectrometry method. As such, the method may further comprise performing a further analysis for each subset of ions output by the ion selection device. For example, for each subset of ions the DIA mass spectrometry method may comprise fragmenting the ions to produce fragmented ions, and mass analysing the fragmented ions. By incorporating the method of ion scheduling of the first aspect into a DIA mass spectrometry method, the ions output within each DIA window may be output with reduced ion losses.

In some embodiments, the method of ion scheduling of the first aspect may be provided as part of a High Dynamic Range (HDR) mass spectrometry method for a m/z range of interest. As such, the method may further comprise accumulating the subsets of ions output by the ion selection device in an ion trap, outputting the accumulated subsets of ions from the ion trap to a mass analyser for mass analysis. In some embodiments, the method may also comprise performing a survey analysis of the ions, wherein the ions are separated into groups and/or subgroups based on the survey analysis. By incorporating the method of ion scheduling of the first aspect into a HDR mass spectrometry method, the time taken to accumulate ions for a HDR method may be significantly reduced. This in turn may allow HDR analyses to be more readily incorporated into DDA or DIA workflows.

In some embodiments, the HDR mass spectrometry method may be performed over a plurality of ion scheduling cycles, wherein for each of the plurality of ion scheduling cycles, a deviation of the ion scheduling device is varied such that the plurality groups of ions span a different m/z range or ion mobility range. Accordingly, the HDR method may reduce ion losses resulting from losses at the fringes of groups of ions output by the ion scheduling device.

In some embodiments, the HDR mass spectrometry method over a plurality of ion scheduling cycles, wherein for each ion scheduling cycle the one or more subsets of ions accumulated in the ion trap are analysed in the MS1 domain to generate a partial HDR mass spectrum. A (full) HDR mass spectrum may then be assembled from the plurality of partial mass spectrums. Such a methodology may be particularly applicable to MS1 spectra acquired by relatively fast mass analysers (e.g. at a frequency of at least 100 Hz), such that a full HDR mass spectrum may be assembled with improved efficiency.

According to a second aspect of the disclosure, a controller for a spectrometry system is provided. The controller is configured to cause the spectrometry system to perform a plurality of ion scheduling cycles to schedule ions for analysis, wherein for each ion scheduling cycle the controller is configured to:
cause an ion scheduling device of the spectrometry system to receive ions, wherein the ion scheduling device separates the ions into a plurality of groups according to their m/z or ion mobility and outputs the groups sequentially to an ion selection device of the spectrometry system; and
for each ion group received by the ion selection device, cause the ion selection device to select a subset of ions from the group and outputs the subset of ions for analysis. For each of the plurality of ion scheduling cycles, the controller causes the ion selection device to select different subsets of ions from the plurality of groups of ions.

As such, the controller of the second aspect may be used to perform a method of ion scheduling in accordance with the first aspect of the disclosure. As such, it will be appreciated that the controller of the second aspect may incorporate any of the optional features and associated advantages of the first aspect.

In some embodiments, the spectrometry system may be a mass spectrometry system which analyses the m/z of the ions. In some embodiments the spectrometry system may be an ion mobility system which analyses the ion mobility of the ions. In some embodiments, the spectrometry system may analyse both the ion mobility and m/z of the ions. For each of the mass spectrometry system and the ion mobility spectrometry system, the ions may be separated by the ion separation device based on their m/z or their ion mobility.

According to a third aspect of the disclosure, a spectrometry system for analysing ions is provided. The spectrometry system comprises an ion scheduling device, an ion selection device, and a controller according to the second aspect of the disclosure. The ion scheduling device is configured to separate the ions into a plurality of groups according to their m/z or ion mobility and to output the groups sequentially to the ion selection device. The ion selection device is configured to select a subset of ions from each group of ions received from the ion scheduling device and to output the subset of ions for analysis by the spectrometry system.

The spectrometry system of the third aspect may be used to perform a method of ion scheduling in accordance with the first aspect of the disclosure. As such, it will be appreciated that the spectrometry system of the third aspect may incorporate any of the optional features and associated advantages of the first aspect.

In some embodiments, the spectrometry system of the third aspect may further comprise an ion mobility analyser or a mass analyser for analysing the ions output by the ion selection device. For example, the mass analyser may be an ion trap mass analyser, an orbital trapping mass analyser, a Time-of-Flight mass analyser, or any other suitable type of mass analyser.

### BRIEF DESCRIPTION OF THE FIGURES

Embodiments of the disclosure will now be described with reference to the following figures in which:

FIG. 1 is a schematic diagram of a technique for separating different m/z ions along an ion guide by opposing an axial pseudopotential with a variable DC force;

FIG. 2 is a schematic diagram of an ion scheduling method, whereby ions of three different m/z values (a, b, c) are accumulated and released in line with resolving quadrupole isolation window;

FIG. 3A shows a schematic diagram of an ion scheduling device according to this disclosure including a linear ion guide ion scheduling device;

FIG. 3B shows a schematic diagram of an ion scheduling device according to this disclosure comprising a bypass;

FIG. 3C shows a schematic diagram of a multi-ion trap ion scheduling device according to this disclosure;

FIG. 4 is a schematic diagram of a mass spectrometry system comprising an ion scheduling device according to an embodiment of the disclosure;

FIG. 5 is a flow diagram of a method of scheduling ions for analysis according to this disclosure;

FIG. 6A is a graph showing the order of MS2 scans for an example ion scheduling

DIA method;

FIG. 6B is a graph showing the deviation in m/z between the centre ion scheduling device extraction window and the centre of the quad isolation window, indicating how much the extraction window should be shifted for each ion-scheduling cycle;

FIG. 7 is a graph showing the order of analyses for DIA methodology including the scheduled quadrupole isolation windows and when to include a bypass full MS scan, and an HDR MS sub-scans;

FIG. 8 is a graph showing the order of analyses for a DIA methodology using a multi-trap ion separator; and

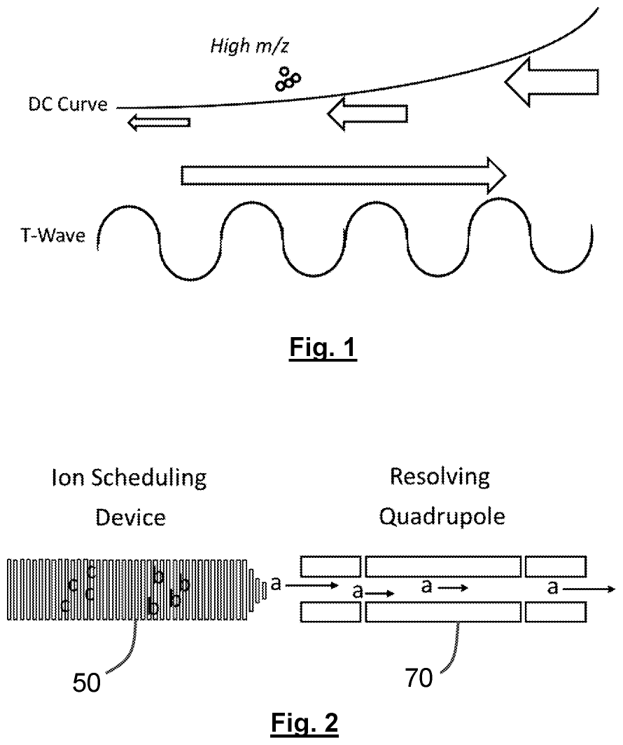

Fig. is 9 is a graph showing the order of analyses for a DIA methodology over two cycles, with interleaving of target regions.

### DETAILED DESCRIPTION

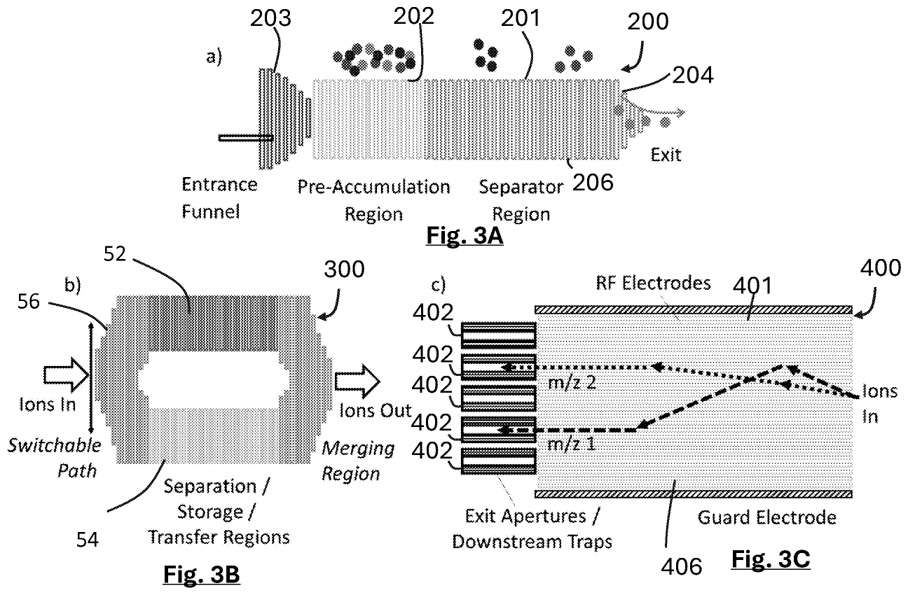

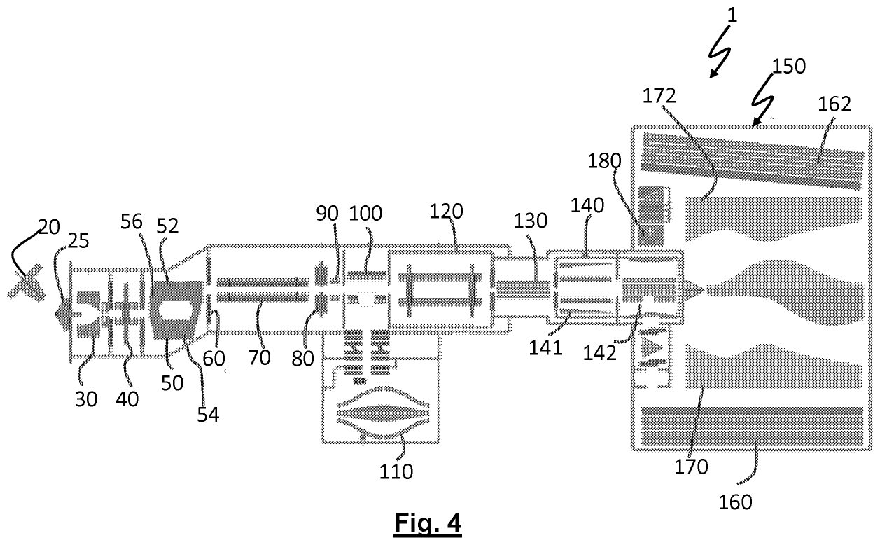

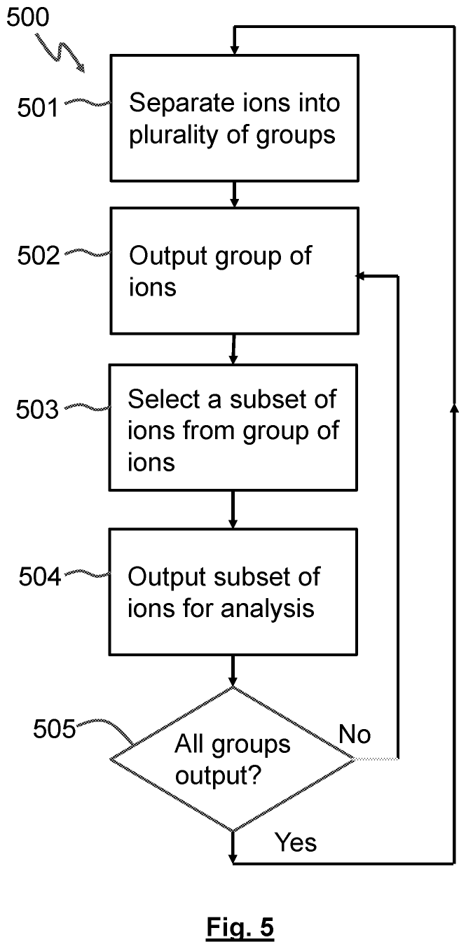

Throughout this disclosure, the term “intensity”, when used in reference to a collection of ions, refers to a quantity of, or a flux of, ions of a particular type that are generated from a common sample and that are detected by a mass spectrometer operated under controlled conditions (e.g., without limitation, during a certain common measurement time period). In practical terms, the ion intensity is the magnitude of a signal that corresponds to the quantity of or flux of ions of the particular ion type that are/is detected. In many instances, the phrase “particular type”, as used above, may refer to ions comprising a particular mass-to-charge (m/z) ratio or a particular restricted range of m/z ratios. In many instances, the measured m/z ratio may be correlated with or indicative of the presence of a particular ion composition (i.e., an ion species). According to an embodiment of the disclosure, a spectrometry system is provided. For example, FIG. 4 shows a schematic diagram of a spectrometry system, which is a mass spectrometry system 1, according to an embodiment of the disclosure. A method of scheduling ions (ion scheduling) according to an embodiment of this disclosure may be performed by the mass spectrometry system 1. In other embodiments, the spectrometry system may comprise an ion mobility analyser (an ion mobility spectrometry system). The mass spectrometry system 1 may be used to analyse a sample supplied from a chromatographic apparatus such as a liquid chromatography (LC) column (not shown in FIG. 4). One such example of an LC column is the Thermo Fisher Scientific, Inc ProSwift (RTM) monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase. In other embodiments, sample molecules may be supplied by any other suitable means, for example a gas chromatography column or other sample delivery methods known to the skilled person. The sample molecules may be ionized using an ion source to generate precursor ions. In the embodiment of FIG. 4, the ion source is an electrospray ionization source (ESI source) 20 which is at atmospheric pressure. Precursor ions generated by the ESI source 20 may then enter a vacuum chamber of the mass spectrometry system 1 and are directed by a capillary 25 into an ion funnel 30. The precursor ions are focused by the ion funnel 30 into an inject filter 40, a small quadrupole which injects the precursor ions into an ion scheduling device 50. In some embodiments, this may operate as a mass filter in order to selectively attenuate the ions. The ion scheduling device 50 shown in FIG. 4 comprises an ion separation path 52 along which ions are separated according to their m/z, and a bypass path 54 along which ions are not separated according to their m/z. Thus, each of the plurality of groups output by the ion scheduling device 50 are elongated along an axial direction of the ion scheduling path 52. The ion scheduling device also comprises a path selection region 56 which selects whether ions travel along the ion separation path 52 or the bypass path 54. As such, the ion scheduling device 50 shown in FIG. 4 is an ion scheduling device comprising a bypass, for example as further shown in FIG. 3B). It will be appreciated that the ion scheduling devices of FIGS. 3A) and 3C) may also be used as the ion scheduling device 50 for the mass spectrometry system 1 as further described below. Further details of ion scheduling devices 50 according to this disclosure are discussed in more detail below. An ion attenuation device 60 may be located at the distal end of the ion scheduling device 50. The ion attenuation device 60 may be configured to control the passage of the precursor ions from the ion scheduling device 50 into a downstream mass selector in the form of a quadrupole mass filter 70. Alternatively, the ion attenuating device 60 may be replaced by a static lens (not shown in FIG. 4) which may be configured to direct ions from the ion scheduling device 50 to the quadrupole mass filter 70 without any intentional attenuation of the ions. The ion attenuation device 60 in some embodiments may also be located after (i.e. downstream of) the quadrupole mass filter 70. The quadrupole mass filter 70 is typically, but not necessarily, segmented and serves as a band pass filter, allowing passage of a selected m/z or limited m/z range whilst excluding precursor ions of other m/z. As such, the quadrupole mass filter 70 is an ion selection device according to this disclosure which is configured to select a subset of ions from a group of ions received by the quadrupole mass filter 70. The quadrupole mass filter 70 can also be operated in an RF-only mode in which it is not m/z selective, i.e. it transmits substantially all m/z precursor ions. Although a quadrupole mass filter 70 is shown in FIG. 1, it will be appreciated that any suitable ion selection device which may filter ions on the basis of their m/z or ion mobility may be used as an ion selection device downstream of the ion scheduling device 50. Furthermore, in some embodiments, more than one ion selection device may be provided. For example, a further mass selection device may be provided downstream of an ion routing multipole 120. In this way, MS3 or MSn scans can be performed if desired (typically using the time of flight (TOF) mass analyser 150 for mass analysis). The mass spectrometry system 1 may be operated in various modes of operation in order to perform analysis of the precursor ions in the MS1 domain and/or the MS2 domain. In a first mode of operation, the precursor ions may be analysed in the MS1 domain using a first mass analyser (for example, the orbital trapping mass analyser 110 of FIG. 4). As such, according to this disclosure, in a first mode of operation of the mass spectrometry system 1 an MS1 analysis may be performed using the orbital trapping mass analyser 110.

In the first mode of operation, precursor ions may exit the quadrupole mass filter 70 through an ion gate 80 and a transfer multipole 90 into a first ion trap 100 (curved trap, or C-trap). The first ion trap 100 has longitudinally extending electrodes which are supplied with RF voltages and end caps that to which DC voltages are supplied. The result is a potential well that extends along the longitudinal axis of the first ion trap 100. In a first mode of operation, ions may be captured and cooled in the first ion trap 100 or transferred to on to the ion routing multipole 120, where the ions are cooled in the ion routing multipole 120. The movement of the ions may be controlled by DC end cap voltages applied to the first ion trap 100. The injection time (IT) of the ions into the first ion trap 100 (or the ion routing multipole 120) determines the number of precursor ions (ion population) that is available for subsequent analysis. From the first ion trap 100, or from the ion routing multipole 120, precursor ions may be directed to different parts of the mass spectrometry system 1, depending on the analysis to be performed.

Where precursor ions are to be analysed by the orbital trapping mass analyser 110, if ions are cooled in the ion routing multiple 120, the ions may subsequently be transferred back to the first ion trap 100 for analysis by the Orbital trapping mass analyser 110. The precursor ions may then be ejected orthogonally from the first ion trap 100 towards the orbital trapping mass analyser 110. As shown in FIG. 4, the orbital trapping mass analyser 110 may be an Orbitrap™ mass analyser sold by Thermo Fisher Scientific, Inc. The orbital trapping mass analyser 110 has an off-centre injection aperture and the precursor ions are injected into the orbital trapping mass analyser 110 as coherent packets, through the off-centre injection aperture. Precursor ions are then trapped within the orbital trapping mass analyser 110 by a hyperlogarithmic electric field and undergo back and forth motion in a longitudinal direction whilst orbiting around the inner electrode.

The axial component of the movement of the ion packets in the orbital trapping mass analyser 110 is (more or less) defined as simple harmonic motion, with the angular frequency in the z direction being related to the square root of the mass to charge ratio of a given ion species. Thus, over time, precursor ions separate in accordance with their mass to charge ratio. Precursor ions in the orbital trapping mass analyser 110 are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced. In the configuration described above, the precursor ions within the mass range of interest (selected by the quadrupole mass filter 70) are analysed by the orbital trapping mass analyser 110 without fragmentation. The resulting mass spectrum is denoted MS1.

Although an orbital trapping mass analyser 110 is shown in FIG. 4, it will be appreciated that other mass analysers may be employed as the first mass analyser according to embodiments of this disclosure. For example, a Fourier Transform Ion Cyclotron Resonance (FTICR) mass analyser may be utilised to analyse the precursor ions in the MS1 domain. Mass analysers, such as the orbital trapping mass analyser 110 and Ion Cyclotron Resonance mass analyser, may also be used in the invention even where types of signal processing other than Fourier transformation are used to obtain mass spectral information from the transient signal (see for example WO-A-2013/171313, Thermo Fisher Scientific). In some embodiments, a TOF mass analyser may also be used in place of the orbital trapping mass analyser 110 to analyse the precursor ions in the MS1 domain.

In a second mode of operation of the mass spectrometry system 1, precursor ions may be analysed by the TOF mass analyser 150 (second mass analyser) in the MS1 domain (an MS1 scan performed by TOF mass analyser 150). The precursor ions to be analysed by the second mass analyser may be mass filtered by the quadrupole mass filter 70. As such, the precursor ions may be filtered to include precursor ions from the m/z range of interest, or from a m/z subrange of interest. In order for the TOF mass analyser 150 to analyse precursor ions, precursor ions may pass from the quadrupole exit lens/split lens arrangement 80 and first transfer multipole 90 into the first ion trap 100 and continue their path through the first ion trap 100 and into the ion routing multipole 120. As such, the first ion trap 100 may effectively be operated as an ion guide in the second mode of operation. Alternatively, the precursor ions may be cooled in the first ion trap 100 and may be subsequently ejected from the first ion trap 100 in an axial direction into the ion routing multipole 120. The precursor ions may then continue through the ion routing multipole 120 and be ejected from the ion routing multipole 120 at the opposing axial end to the first ion trap 100. As such, the ion routing multipole 120 may also effectively be operated as an ion guide in the second mode of operation. The ejected precursor ions pass into an ion guide 130. The ion guide 130 is configured to guide the precursor ions from the ion routing multipole 120 into an ion processor 140. The ion processor 140 is configured to process ions into an ion packet suitable for injection into the TOF mass analyser 150. The ion processor 140 may comprise an RF voltage-controlled third ion trap containing a buffer gas. For example, a suitable buffer gas is nitrogen at a pressure in the range 5×10⁻⁴ mBar to 2×10⁻² mBar. The ion processor may optionally be used to induce fragmentation of the ions for analysis in the

MS2 domain. For analysis in the MS1 domain, fragmentation of the ions is not desired, so ions may be transferred from the fragmentation chamber 141 of the ion processor to the extraction trap 142 of the ion processor. The ion processor 140 has the ability to quickly switch off the applied RF voltage and apply a DC voltage to extract the trapped precursor ions. A suitable flat plate extraction trap, also referred to as a rectilinear ion trap, is further described in US 9,548,195 (B2).

Although an ion processor 140 (ion trap) is shown in the embodiment of FIG. 4, the skilled person will appreciate that other methods of forming an ion packet of precursor ions may also be provided. For example, relatively slow transfer of ions through a multipole can be used to affect bunching of ions, which can subsequently be ejected as a single packet to the TOF mass analyser 150. Alternatively, orthogonal displacement of precursor ions may be used to form an ion packet. Further details of these alternatives are found in US-A-20030001088 which describes a travelling wave ion bunching method, the contents of which are herein incorporated by reference.

In FIG. 4, the TOF mass analyser 150 shown is a multiple reflection time of flight mass analyser (MR-TOF). The TOF mass analyser 150 is constructed around two opposing ion mirrors 160, 162, elongated in a drift direction. The mirrors are opposed in a direction that is orthogonal to the drift direction. The ion processor 140 injects ions into the first mirror 160 and the ions then oscillate between the two mirrors 160, 162. The angle of ejection of ions from the extraction trap 140 and additional deflectors 170, 172 allow control of the energy of the ions in the drift direction, such that ions are directed down the length of the mirrors 160, 162 as they oscillate, producing a zig-zag trajectory. The mirrors 160, 162 themselves are tilted relative to one another, producing a potential gradient that retards the ions' drift velocity and causes them to be reflected back in the drift dimension and focused onto a detector 180. Precursor ions accumulated in the ion processor 140 are injected into the TOF mass analyser 150 (second mass analyser) as a packet of ions. The time taken for the precursor ions to arrive at the detector 180 is recorded by the TOF mass analyser 150 and used to generate an MS1 mass spectrum of the precursor ions. In a third mode of operation of the mass spectrometry system 1, the TOF mass analyser 150 (second mass analyser) may be used to analyse the precursor ions in the MS2 domain (a MS2 scan).

In order to analyse the precursor ions in the MS2 domain, some of the precursor ions may be transferred from the quadrupole mass filter 70 to the ion routing multipole 120 in a manner similar to second mode of operation discussed above. The precursor ions to be transferred may be an ion scheduler group of ions which have been output from the ion scheduling device 50, or a group of precursor ions which have not been subjected to ion scheduling. The output ions (e.g. the ion scheduler group of ions) may be further mass selected by the quadrupole mass filter 70. For example, the output ions may be further mass selected to include targeted precursor ion species, or further mass filtered using an m/z isolation window of the quadrupole mass filter 70 (e.g. as part of a DIA methodology), as discussed in more detail below.

Ions may then be transferred to the fragmentation chamber 141 of the ion processor 140. The fragmentation chamber 141 is, in the mass spectrometry system 1 of FIG. 4, a higher energy collisional dissociation (HCD) device. A buffer gas may be supplied to the fragmentation chamber 141. When precursor ions are to be fragmented, the kinetic energy of the precursor ions may be increased, so that precursor ions arriving at the fragmentation chamber 141 and colliding with buffer gas molecules results in fragmentation of the precursor ions into fragment ions.

Although a HCD fragmentation chamber 141 is shown in the ion processor 140 of FIG. 4, other fragmentation devices may be employed instead, employing such methods as collision induced dissociation (CID), electron capture dissociation (ECD), electron transfer dissociation (ETD), photodissociation, and so forth.

Fragmented ions may be ejected from the fragmentation chamber 141 into the extraction trap 142 of the ion processor. The ejected fragmented may be accumulated in the extraction trap 142 to form an ion packet. The fragmented ions may then be injected into the TOF mass analyser 150 as described above.

It will be appreciated that in some embodiments, the first mass analyser (orbital trapping mass analyser 110) and the second mass analyser (TOF mass analyser 150) may be operated concurrently. That is to say, the mass spectrometry system 10 may be operated in a first mode of operation concurrently with the second or third mode of operation. According to this disclosure, the ion scheduling device 50 may be operated in order to output groups of ions (and/or subsets of ions from the quadrupole mass filter 70) such that the orbital trapping mass analyser 110 and the TOF mass analyser 150 may be operated in an efficient manner and also with improved dynamic range.

The mass spectrometry system 1 may be under the control of a controller (not shown in FIG. 4) which, for example, is configured to control the timing of ejection of the trapping components, to control one or more power supplies (not shown) to set the appropriate potentials on the electrodes of the quadrupoles etc. so as to focus and filter the ions, to capture the mass spectral data from the orbital trapping device 110, to capture the mass spectral data from the orbital trapping mass analyser 110 and the TOF mass analyser 150, control the sequence of MS1 and MS2 scans and so forth. It will be appreciated that the controller may comprise a computer that may be operated according to a computer program comprising instructions to cause the mass spectrometry system 1 to execute steps in an accordance with the methods described herein.

Next, methods of ion scheduling utilising an ion scheduling device 50 will be described. FIG. 1 is an explanatory diagram which shows one general principle of ion scheduling using a travelling wave. It will be appreciated that the diagram shown in FIG. 1 is only one possible mechanism for ion scheduling and that other methodologies of ion scheduling may also be applied to the methods of this disclosure. In FIG. 1, a non-linear DC potential (an opposing potential gradient) and a travelling wave (a time-varying potential) induce the separation of ions over a length. FIG. 1 shows the travelling wave at a single instance in time; in practice the travelling wave is caused to travel continuously along an axial direction of the ion scheduling device (left to right in FIG. 1). The opposing DC and pseudopotential forces cause ions of different m/z to settle at different positions.

To achieve the m/z dependent separation of FIG. 1, ions may be separated by opposing a potential gradient (e.g. a static field) with a pseudopotential force generated by a dynamic (time-varying) potential. In some ion scheduling devices 50 of the present disclosure, an axial pseudopotential generated by a travelling wave (T-Wave) opposes a rising DC gradient. Such a T-Wave could be a multi-phase (e.g. 3-phase, or higher) travelling wave. The pseudopotential force pushes ions until they reach a region where the DC force is equal to or greater than the pseudopotential force, at which point the ions become trapped (or if the DC gradient is insufficient then the ions are pushed out of the device). As pseudopotential force is dependent on m/z, the trapping position of the ions also depends on their m/z. Hence, ions may be trapped at various different positions in the separation (axial) direction. As such, the plurality of groups output by the ion scheduling device are elongated along the axial direction of the ion scheduling device.

Separated ions (or separated groups of ions) may be released from the ion scheduling device 50 in an m/z-dependent fashion by scanning/stepping the applied DC potential or the travelling wave amplitude/frequency (or duty cycle/pulse velocity for digital waveforms). Alternatively, many other ways of extracting ions from the guide may be applied: the DC gradient and T-Wave may be removed and ions released over time based on their spatial separation/drift time, or a very slow travelling wave applied to drive out ions in slow bunches, etc. Accumulated ions may then be released, for example to quadrupole mass filter 70 matching their m/z, and the losses at the quadrupole may thus be mitigated. In particular, it will be appreciated that in some embodiments the ion scheduling device 50 may be configured to separate ions on the basis of ion mobility. As such, the ion scheduling device 50 may separate the ions into a plurality of groups, each group having a different ion mobility range. The ion scheduling device 50 may then output the ions sequentially based on their ion mobility (e.g. groups in order of increasing ion mobility, or groups in order of decreasing ion mobility).

As the application of a travelling wave potential typically requires axial segmentation of electrodes, the ion scheduling arrangement shown in FIG. 1 may be implemented using a stacked ring ion guide and/or related structures for example. FIG. 3A shows an example of a linear ion scheduling device 200, which is an apparatus for separating ions in which the approach of FIG. 1 may be implemented. The linear ion scheduling device 200 comprises a separator region 201, a pre-accumulation region 202, a funnel/initial capture region 203, and an ion outlet 204.

In this specific example, the linear ion scheduling device 200 has a stacked ring structure, also including optional sections for ion capture from an inlet capillary and a pre-accumulation region 202 to maximise duty cycle. In addition to a separation region 201, in which a T-Wave and DC gradient are applied, the linear ion guide ion scheduling device 200 is shown as comprising a similar pre-accumulation region 202 for pre-accumulation of ions whilst the separator 201 is in operation. An ion funnel 203 may receive ions from an inlet capillary, or from an ion gate as shown in FIG. 4, and a small, funnelled region compresses the extracted ions as the ions pass out of the device to a higher vacuum (lower pressure) region. The funnelled 203 and pre-accumulation regions 202 may have their own DC offsets and gradients imposed, and a controllable (i.e. variable) DC barrier may be provided between the accumulator 202 and the separator 201. Potentials (e.g. from auxiliary electrodes, which are not shown) can be applied within the guide to cause the ions to move laterally (i.e. perpendicular to the axis of the ion guide), to permit spreading of high amounts of charge over a wider area to reduce space charge effects. After the ions have passed through the separation region 201, they exit the apparatus through the ion outlet 204, for example to a higher vacuum (lower pressure) ion guide. Hence, in generalised terms, the separation regions and/or accumulation regions described herein may be a vacuum region(s). The separation region and/or accumulation regions may be at a lower pressure than an upstream region (i.e. a region that is upstream of the separation region and/or accumulation region) of the apparatus and/or may be at a higher pressure than a downstream region (i.e. a region that is downstream of the separation region and/or accumulation region) of the apparatus. Various gas-tight housings and pumping can be provided to ensure a vacuum is formed.

The properties of the travelling wave may preferably be set such that ions pass through the waves, such that the ions feel the influence of a pseudopotential force rather than being completely entrained in the waves. For example, the frequency and/or voltage amplitude of the travelling wave may be varied to achieve this. In principle, a high enough travelling wave potential will just carry ions away and there will be no separation, unless an opposing DC is set high enough to balance this effect. Therefore, the opposing potential and the time-varying potential may be fine-tuned to optimise separation performance.

The linear ion scheduling device 200 may be operated to output ions (or groups of ions) separated according to their m/z. Firstly, ions may be transferred from the inject filter 40 to the pre-accumulation region 202 via the ion funnel 203. Ions (e.g. ions of mixed m/z, spanning a m/z range of interest for example) may accumulate in the pre-accumulation region to form a packet of ions. The packet of ions may then be transferred from the pre-accumulation region 203 to the separation region 201, which may be achieved via application of either DC gradient/offset across the pre-accumulation region 203 or a travelling wave to push ions along. Once the pre-accumulation region 203 has been emptied of ions, the further transfer of ions from pre-accumulation region 203 to the separation region 201 is blocked (e.g. by activating an ion gate) and the pre-accumulation region 203 begins accumulating further ions as they enter. In parallel to this, the process of separation begins in the separation region 201. The DC gradient (which is preferably curved) amplitude is reduced (or alternatively an increase in travelling wave amplitude is provided, or both) to the level required for the first, lowest, m/z extraction window to exit. After a short delay (typically on the order of 0.25-5 ms), the first group of ions are extracted from the separation region 201. The first group of ions have a m/z falling within a first m/z extraction window, which may be the lowest m/z extraction window of the plurality of m/z extraction windows to be used in the ion scheduling cycle.

For example, the mass spectrometry system 1 may have a m/z range of interest of 300 m/z to 900 m/z. Within this m/z range of interest, each group of ions may each span a m/z extraction window of about the same size. For example, each m/z extraction window width may be at least: 50 Th, 70 Th, 100 Th, 150 Th, 200 Th. The ions may be scheduled such that the group of ions closest to the exit have a relatively low m/z, followed by a group of ions further within the separation region 201 having a higher m/z, with groups of ions still further within having a higher still m/z and so on. As such, each group of ions may have a different m/z range. Thus, the groups of ions may be output from the ion scheduling device 200 sequentially in order of m/z. For example, for a m/z range of interest of 300 to 900 m/z and a m/z extraction window width of about 100 Th, the first group of ions (lowest m/z) may have a range of 300 to 400 m/z. The second group of ions may have a range of 400 to 500 m/z, the third group having a range of 500 to 600 m/z and so on.

The extracted ions may exit the ion scheduling device 50 and travel to the downstream quadrupole mass filter 70 (or other ion selection device) for further ion selection. The DC gradient applied to the ion scheduling device 50 may then be further reduced to the next m/z extraction window in the sequence and so on until the m/z range of interest is exhausted (i.e. m/z extraction windows spanning the m/z range of interest have each been emptied of ions), whereupon the accumulation region may be once again emptied, and the cycle repeated.

Thus, in each cycle of the linear ion scheduling device 200, ions may be output from the linear ion scheduling device 200 according to their m/z. That is to say, ions may be output from the linear ion scheduling device 200 in a sequence of groups, each group generally increasing m/z. In particular, ions may be extracted from the linear ion scheduling device 200 using a sequence of m/z extraction windows. It will be appreciated that the general techniques of ion scheduling described in relation to the linear ion guide 200 may also be applied to the bypass ion scheduling device 300 of FIG. 3B and the multiple-ion trap ion scheduling device 400 of FIG. 3C.

As shown in FIG. 3A, ions may be output from the linear ion scheduling device 200 in approximate m/z order of the groups, wherein they are further isolated by quadrupole mass filter 70. The fill time (accumulation time, or injection time) for the quadrupole mass filter 70 may be controlled by the controller. In particular, the fill time may be controlled based on known properties of the group of ions being injected into the quadrupole mass filter 70 from the ion scheduling device 50 in order to try to improve the dynamic range of the spectrometry system, as described in further detail below.

Next a method 500 of scheduling ions for analysis by a mass analyser over a m/z range of interest will be described with reference to the flow chart of FIG. 5. The method 500 may be performed by the mass spectrometry system 1 of FIG. 4.

FIG. 5 shows the steps performed by the mass spectrometry system 1 for a single ion scheduling cycle. According to the method 500, a plurality of ion scheduling cycles are performed.

Each ion scheduling cycle generally involves the filling of the ion scheduling device 50 with ions (e.g. filling the ion separation region 201 with ions) and subsequently emptying the same ions from the ion scheduling device 50, the ions being separated into groups according to their m/z or ion mobility.

As part of the ion scheduling cycle, step 501 comprises the ion scheduling device 50 receiving ions, wherein the ion scheduling device separates the ions into a plurality of groups according to their m/z or ion mobility.

According to step 502, the ion scheduling device outputs a group of ions to an ion selection device, for example quadrupole mass filter 70. The sequence in which the groups of ions are output to the ion selection device may depend on the order in which the groups of ions are arranged within the ion scheduling device 50. For example, in the ion scheduling device 200, the group of ions closest to the ion outlet 204 will be output first in the sequence, followed by the next closest group and so on.

In step 503, the quadrupole mass filter 70 receives a group of ions from the ion scheduling device 50. The quadrupole mass filter 70 then selects a subset of ions from the group. In the case of the quadrupole mass filter 70, the subset of ions selected are ions within a subset of the m/z range of the group of ions. That is to say, the quadrupole mass filter 70 filters the group of ions to a narrower m/z range than the m/z range of ions output by the ion scheduling device 50.

It will be appreciated that the ion scheduling device 50 has a lower resolution than the quadrupole mass filter 70. As such, the ion scheduling device 50 separates ions into groups of ions, each group having a first m/z window width (or first ion mobility width). The quadrupole mass filter 70 may then select a subset of the group of the ions for analysis. The subset of ions may have a second m/z window width narrower than the first m/z window width. It will be appreciated that it may not be possible for the quadrupole mass filter 70 to isolate every ion species present in the group of ions (at least not in a time efficient manner). Thus, a single subset of ions may be selected from a group of ions provided to the quadrupole mass filter 70.

In step 504, the quadrupole mass filter 70 outputs the subset of ions for analysis. For example, in the embodiment of FIG. 4, ions may be output to the orbital trapping mass analyser 110 or the TOF mass analyser 150 for analysis. The subset of ions may be analysed in the MS1 or MS2 domain (or even MS3, MSn etc.).

As indicated by steps 505, the steps 502, 503, and 504 of outputting a group of ions to the quadrupole mass filter 70, selecting a subset of ions, and outputting the subset of ions may be repeated for each group of ions separated by the ion scheduling device. Once each separated group of ions has been output, step 505 indicates that the method may return to step 501 for a new ion scheduling cycle.

It will be appreciated that the quadrupole mass filter 70 may select a subset of ions and output the ions for analysis (steps 503 and 504) whilst the next group of ions is being readied for output by the ion scheduling device 50. As such, it will be appreciated that steps 502-504 may be performed concurrently during at least some point of each ion scheduling cycle.

For each of the plurality of ion scheduling cycles, the ion selection device selects different subsets of ions from the plurality of groups of ions. For example, for a typical DIA analysis the plurality of ion scheduling cycles may be performed such that over the plurality of ion scheduling cycles the subsets of ions output span a mass range of interest for the DIA analysis. In some embodiments, the subsets of ions may continuously span a m/z range of interest (i.e. no gaps in the m/z range of interest). In some embodiments, the subsets of ions may overlap in m/z, while in other embodiments the subsets of ions may span the m/z range of interest contiguously.

Methods of ion scheduling according to this disclosure are applicable to high sensitivity mass spectrometry systems. In particular, ion scheduling according to this disclosure may be compatible with relatively high frequency (e.g. 200-400 Hz) spectral acquisition. Ion scheduling techniques according to this disclosure may also greatly assist with improved speed switching between MS1 and MS2 analyses. Further, the scheduling of ions in groups according to m/z or ion mobility may provide for improved control of the ion population of space charge limited downstream trapping regions. For example, in some embodiments of the disclosure, the method of ion scheduling may be provided as part of a Data Independent Acquisition (DIA) mass spectrometry method. In such embodiments, the DIA method generally aims to analyse ions within a m/z range of interest of e.g. 300-900 m/z. Within this range, the DIA method aims to perform MS2 analyses of 10 Th window width (e.g. 300-310, 310-320, 320-330 . . . 890-900 m/z). The method of ion scheduling outputs subsets of ions having a second m/z window width of 10 Th. For each subset of ions output, the DIA method further comprises fragmenting the ions to produce fragmented ions and mass analysing the fragmented ions. For example, each subset of ions may be fragmented in the fragmentation chamber 120 of FIG. 4 and then transferred to the TOF mass analyser 150 for analysis.

In order to produce each subset of ions, the ion scheduling device may make sequential extractions of groups of ions having a first m/z window width of e.g. 100 Th (e.g. 300-400, 400-500, . . . 800-900 m/z). The quadrupole mass filter 70 may then take a single 10 Th wide subset of ions from group of ions per cycle, e.g. 300-310, 400-410 . . . 800-810 then 310-320, 410-420 . . . 810-820 in the next cycle, and so on until all DIA windows are analysed. If each ion scheduling cycle may be completed in ~100ms, then the full DIA cycle would take about a second.

For an ion scheduling device 50, the time taken to perform an ion scheduling cycle may be determined by the speed of the device, the required signal amplification, any limit on ion accumulation time to prevent overload, and the number of separate ion groups to be generated in the cycle. For relatively low intensity ion populations, it may be desirable to maximise the fill time and number of target windows, which normally might relate to a slow cycle but gives the highest signal amplification.

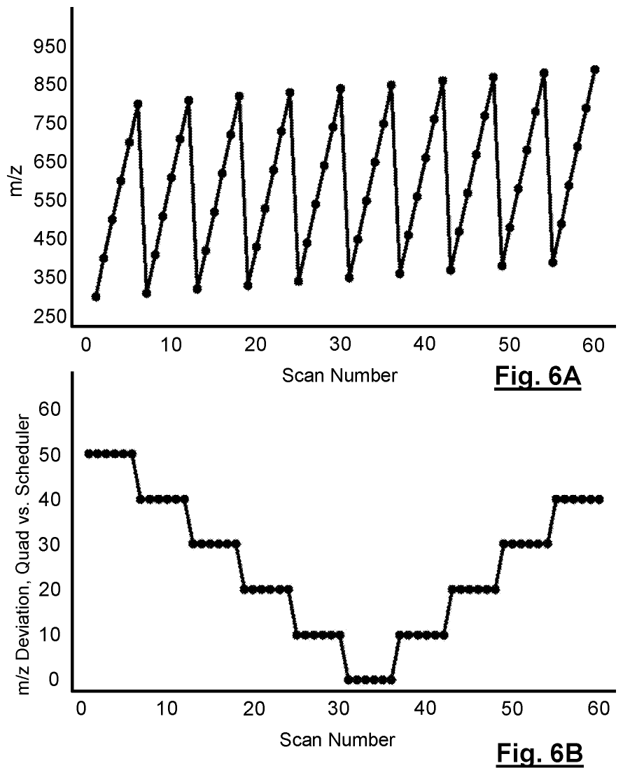

To further improve the ion transmission efficiency of the ion scheduling method, subsets of ions may be selected from a central range of each group of ions. Precursor ions at the fringes of each ion group may be subject to transmission losses from the ion scheduling device 50. In order to allow all DIA windows to be analysed, whilst selecting from a central region of each group of ions, the method may comprise shifting the window ranges for the ion scheduling device 50 for each ion scheduling cycle so that they are centred on the DIA windows to be extracted each cycle. As such, for each of the plurality of ion scheduling cycles, a deviation of the ion scheduling device is varied such that the plurality groups of ions span a different m/z range or ion mobility range. FIG. 6A shows this simple DIA order for a 60 scan DIA sweep, or series of steps, covering 300-900 m/z with 10 Th wide subsets of ions to be analysed. FIG. 6B shows the deviation in m/z between the centre of the ~100 Th extraction window of the ion scheduling device 50 and the centre of the quadrupole isolation window.

The deviation of the ion scheduling device to vary the m/z range of each group of the ions output by the ion scheduling device 50 may be implemented as a shift in the timing or magnitude of the AC or DC voltage ramp used to separate the ions. For example, for the linear ion scheduling device 200 as shown in FIG. 3A, the deviation may be accomplished via a shift in the applied timings of the AC or DC voltage ramp. For devices that constantly fill into an array of traps, such as the multi-trap ion scheduling device 400 shown in FIG. 3C the deviation of the ion scheduling device may be varied over several ion scheduling cycles to account for the parallel filling of the ion traps 402. Further discussion of the filling of multi-trap ion scheduling devices is provided below.

It will be appreciated that for good quantitation during a DIA method, it may be desirable to perform 5+ measurements of a single species over the time it takes that species to elute. Typically, a single species elutes over multiple seconds, so a single DIA cycle is typically around 1 s in duration. As analysis of the m/z range of interest is split into a plurality of ion scheduler cycles due to the limited resolution of the ion scheduling device 50, the number of ion scheduling cycles is defined by the number of DIA analyses to be performed/separation power of the ion scheduling device, i.e. if one can only fit 10 reasonably well separated precursors across the m/z range per IS cycle, and there are 100 precursor windows to run through, then 10 ion scheduling cycles will be required for each DIA cycle.

The mass spectrometry system 1 of FIG. 4 comprises a TOF mass analyser 150 which can operate at a frequency 200 Hz. As such, the mass spectrometry system can process 10 subsets of ions every 100 ms (i.e. one ion scheduling cycle) such that a DIA cycle of 100 precursor windows can be analysed in about 1 s.

In a single path device such as the linear ion scheduling device 200 of FIG. 3A, a typical ion scheduling cycle will subsequently occupy the downstream analyser (e.g. TOF mass analyser 150) for a minimum period of time. For example, where the ion scheduling device 50 outputs 10 groups, 10 subsets of ions will be sequentially generated for analysis. These sequential subsets of ions may prevent other analyses from being performed concurrently or which may typically be interleaved into a mass spectrometry experiment, such as current measurement scans for AGC, and regular full-MS or some targeted scans. To allow for other analyses to be performed concurrently with the subsets of ions output by the ion scheduling device 50, the ion scheduling device 300 may be provided with a bypass, for example as shown in FIG. 3B.

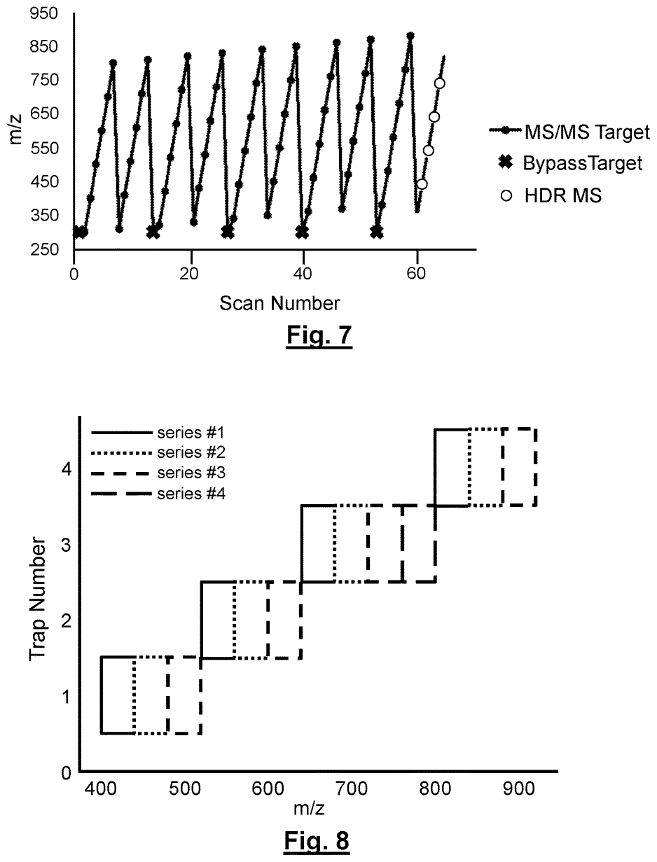

The ion scheduling device 300 in FIG. 3B incorporates a bypass. The path selection region 56 may direct a packet of ions along the bypass path 54 and on to the quadrupole mass filter 70. This allows a packet of ions to be scheduled during an ion scheduling cycle without greatly interfering with the operation of the ion scheduling device 300. FIG. 7 shows an example where the bypass path 54 is utilised to perform MS1 analyses (labelled “Bypass MS” in FIG. 7) between every other IS cycle. For example, the bypass path may be used to transfer ions to the orbital trapping mass analyser 110, which typically has a slower analysis time than the TOF mass analyser 150. The frequency at which the bypass MS analyses are performed may depend on the duration of each ion scheduler cycle, relative to the duration of the Bypass MS scan and/or on the desire for e.g. full MS analyses, which is usually linked to the chromatographic peak width, and thus only indirectly linked to the optimum speed of the IS cycle. FIG. 7 also includes ion scheduling cycle dedicated to making injections for high dynamic range (HDR) MS analysis, an application which is discussed in further detail below. While the embodiment of FIG. 3B comprises a bypass path 54 which extends generally parallel to the ion scheduling region 52, in other embodiments the bypass path 54 may extend between an inlet and an outlet of the ion scheduling device 50, with the ion scheduling region 52 arranged transverse to the bypass path 54, for example in a T-shaped arrangement.

Methods of ion scheduling according to this disclosure may also be performed by multi-trap ion scheduling devices 400. An example of a multi-trap ion scheduling device 400 is shown in FIG. 3C. For the multi-trap ion scheduling device 400, ions of different m/z (or ion mobility) may be separated orthogonally (i.e., orthogonally to the general linear direction of the ion scheduling device) by a plurality of RF electrodes 406 of the multi-ion trap ion scheduling device 400. The RF electrodes 406 separate the ions orthogonally in a similar manner to the RF electrodes 206 of other ion scheduling devices through a combination of a T-wave and a DC potential. Ions are also directed along the axial length of the ion scheduling device 400 such that the separated groups of ions are each directed into one of a plurality of ion traps 402 as the ions transit an ion separation region 401 of the multi-trap ion scheduling device 400. Ions of different m/z take different paths through the ion separation region 401 and are therefore directed to the different ion traps 402. Ions are confined in the lateral direction (transverse to the axial direction of ion travel) by the RF electrodes 406 and DC guard electrodes 410, 412 provided on opposing sides of the multi-trap ion scheduling device 400.

In generalised terms, each ion trap 402 may define an outlet allowing the ions trapped within the ion trap 402 to exit the ion separation region 401. There can be two, three, four or more ion traps 402, with each being used to permit ions of a respective m/z extraction window to exit the ion separation region 401. Each m/z extraction window may span a first m/z window width, similar to the embodiments discussed above. The plurality of m/z extraction windows provided by the plurality of ion traps 402 may span the m/z range of interest. For example, for a m/z range of interest of 300-900 m/z, the five ion traps 402 may have m/z acceptance windows of 300-420 m/z, 420-540 m/z, 540-660 m/z, 660-780 m/z, and 780-900 m/z.

The range of m/z of ions that pass through each ion trap 402 can be adjusted or tuned, for example through appropriate selection of voltages applied by the electrode arrangements and/or by adjustment of gas flows within the separation region. Thus, ions of a given m/z could be directed to a certain ion trap 402 of the plurality of ion traps 402 under certain conditions but could be directed to a different ion trap 402 under other conditions. As such, the voltages applied to the ion traps may be subject to a deviation in for each ion scheduler cycle in order to ensure that the subset of ions to be selected from each group is centred in the group as discussed above.

The plurality of ion traps 402 are preferably spaced apart in direction transverse to the axial length of the ion scheduling device 400. Thus, the ions that separate in the transverse direction are divided into groups of ions corresponding to m/z extraction windows of the ion traps 402 of the ion scheduling device 400.

An additional potential (e.g. a DC force) may be applied to the multi-ion trap ion scheduling device 400 to pull ions towards the exits along the axial length of the device 400 (i.e. horizontally in FIG. 3C). For example, a DC gradient may be applied to a DC-only top plate PCB (not shown in FIG. 3C), or a shaped counter-electrode (if RF carpet type), or additional DC electrodes mounted between the RF electrodes 406, or by shaping of the RF electrodes 406. In the embodiment of FIG. 3C, the individual RF electrodes 406 extend along the axial length of the ion scheduling device 400, i.e. the electrodes extend towards the outlets of the ion traps 402, or are orthogonal to the direction in which the plurality of ion traps are spaced apart. Therefore, the RF electrodes 406 may have the travelling wave/opposing DC applied directly to them in order to separate the ions into ion scheduler groups. Further configurations of a multi-ion trap ion scheduling device 400 are described in GB 2312733.5, the contents of which are herein incorporated by reference.

For some multi-trap ion scheduling devices 400, ions may be proportionally split between >1 ion trap 402 due to the separation resolution of the device. In such cases, it may be preferable to output groups of ions based on trap position rather than strictly based on m/z or ion mobility. That is, where a subset of ions are considered to fall into at least two adjacent ion traps 402, both ion traps 402 may output ions forming a single group of ions to the quadrupole mass filter 70. This may allow for more efficient utilisation of the available ion traps. Additionally for low intensity species, or for accurate quantitation, ions from >1 ion trap 402 could be used simultaneously to form a subset of ions. A signal correction function may be provided to account for how ion signal is split between different ion traps 402, which may be a calibrated function.

In some embodiments, the ion scheduling device 50 may be supplied with a relatively high ion current. In such circumstances, the space charge capacity of the mass spectrometry system, particularly that space charge capacity of the ion scheduling device 50 may be taken into account. Typical ion scheduling device 50 designs have an ion capacity far in excess of 1 M ions, with 10 M being achievable by ion scheduling devices 50 comprises stacked ring ion guides or broad RF surfaces. In some embodiments, an ion scheduling device 50 may have an ion capacity of at least 100 M ions, with such an ion scheduling device typically having a 100 ms ion scheduling cycle duration. Such a capacity is readily compatible with a typical nano-electrospray ion sources 20 which may generate about a billion ions per second. Where ion currents are relatively high, ion scheduling cycle times may be decreased to prevent excessive numbers of ions being accumulated within the ion scheduling device. In some embodiments, a duration of the ion scheduling cycle may be varied dynamically based on an ion current measured by the mass spectrometry system 1. Thus, the number of precursors in an ion scheduling cycle may be reduced in response to a relatively high current measurement.

Alternatively, in some embodiments the ion scheduling device 50 may be provided with a mechanism to offload excess ions. For example, in the mass spectrometry system 1 of FIG. 4, a dump voltage may be applied to a lens or electrode between the ion source 20 and the ion scheduling device 50 (e.g. a dump voltage applied to the inject filter 40 or a pre-filter). For multi-trap ion scheduling devices 400 (e.g. as shown in FIG. 3C), ion gates (not shown in FIG. 3C) may be provided at the entrance to each ion trap 402, thereby allowing rejection of specific high intensity ion populations. Alternatively, an ion gate could be provided in a pre-accumulation region 202 to which a dump voltage may be applied to reduce the ion population (or the dump voltage may be applied directly to the electrodes of the pre-accumulation region 202).

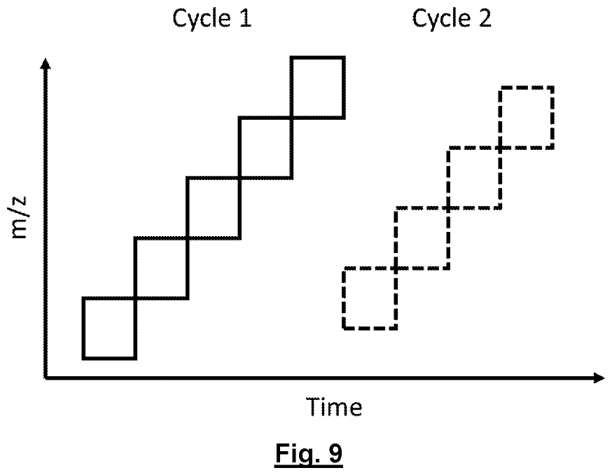

FIG. 8 shows an example of a DIA method applied to an ion scheduling device whereby differential mobility separation pulls ions of differing ion mobility continuously into a series of four separate ion traps 402, which are emptied in sequence. In the first ion scheduling cycle, the first trap empties and the downstream quadrupole isolates m/z 400-440, then the second ion trap empties and the downstream quadrupole isolates m/z 520-560, and so on. The second ion scheduling cycle then runs m/z 440-480, 560-600 and so on. In some embodiments, the upper end of the m/z range of interest may have a wider spacing and an extra cycle, to accommodate the lower resolution at higher m/z values. This embodiment provides for parallel operation of the ion traps 402. This in turn allows the DIA methodology to utilize longer accumulation times for each ion trap 402.

In some circumstances, species with mobility values that are not well centred to the acceptance of a single ion trap 402 may become strongly split between two ion traps 402. One option is to empty two traps to strengthen the signal for such species, though it reduces the gain possible with the device. In some embodiments, a deviation may be applied to the mobility separator's settings between ion scheduling cycles to align the centres of the acceptance windows of the ion traps with the mobility of the desired analytes in that cycle. As such, a deviation of the ion scheduling device may be varied such that the plurality groups of ions span a different m/z range or ion mobility range for each io scheduling cycle, similar to the approach discussed above in relation to FIG. 6.

While the above techniques have discussed DIA methodologies, it will be appreciated that methods of ion scheduling according to this disclosure may also applied to other spectrometry experiments. For example, methods of ion scheduling according to this disclosure may be provided as part of a Data Dependent Acquisition (DDA) mass spectrometry method. Such DDA methods may be performed by the mass spectrometry system 1 of FIG. 4. In such embodiments, the method further comprises obtaining a list of analytes of interest and associated m/z. For example, the DDA method may include obtaining a list of target m/z corresponding to precursor ions, or analyte of ions of interest identified in an earlier mass analysis forming part of a DDA method. For each group of ions received by the quadrupole mass filter 70, the quadrupole mass filter 70 selects a subset of ions from the group based on the list of analytes of interest and associated m/z. The output subsets of ions may be analysed in the MS2 domain (or MS1 domain) as will be appreciated from the above discussion.

Some mass spectrometry systems 1 may periodically perform relatively fast MS1 measurements spanning the m/z range of interest (a full MS analysis). Such measurements may be used to support ion current calculations and thus control inject time to the C-Trap 100, ion processor 140, and the ion scheduling device 50. Such measurements are often referred to as Automatic Gain Control (AGC) measurements. In some embodiments, such AGC measurements may be integrated between ion scheduling cycles or performed using a bypass region 54 of an ion scheduling device 300, for example as discussed above in relation to FIG. 7.

Methods of ion scheduling according to this disclosure may be provided as part of a High Dynamic Range (HDR, or Boxcar) method. In general, the HDR scanning method is an analysis performed in the MS1 domain which splits the m/z range of interest into a series of separate quadrupole isolation windows, either pre-programmed or generated dynamically based on the location (e.g. m/z) of relatively intense ion species. The ions of each quadrupole isolation window are accumulated in the C-Trap 100 and injected together into the orbital trapping mass analyser 110. These separate windows are lossy in the same way MS/MS acquisition is lossy, and the beam time required to accumulate ions for a 6 or 12 window HDR mass spectrometry analysis is relatively lengthy (i.e. measured in seconds) compared to the 200 Hz operation of the TOF mass analyser 150. Methods of ion scheduling according to this disclosure can be applied to the HDR method to bring down the required beam time by about an order of magnitude. In other words, an HDR equivalent spectrum may be generated from the m/z or mobility dependent release of ions from an ion scheduling device 50, providing that portions of the released ions (containing the relatively intense species) are ignored or otherwise attenuated.

In some embodiments, for example where the ion scheduling device is a linear ion scheduling device 200 as shown in FIG. 3A and FIG. 4, a HDR method of mass spectrometry may be performed in accordance with the methods of ion scheduling according to this disclosure. As such, the ions may be separated into groups of ions by the ion scheduling device 200, and then subsets of ions may be selected by the quadrupole mass filter 70. The subsets of ions output may then be accumulated in a further ion trap (e.g. C-trap 100). The method further comprises outputting the accumulated subsets of ions from the ion trap to a mass analyser for mass analysis. For example, the accumulated subsets of ions may be output to the orbital trapping mass analyser 110.

In some embodiments, the separation of the ions into groups and/or selection of subsets of ions may take into account the relative intensity of ion species present. For example, the HDR method may take into account information indicative of the m/z and associated intensities of ions present, which may be obtained from a survey analysis of the ions (i.e. a MS1 analysis of the m/z range of interest). As such, the ions may be separated into groups and/or subsets of ions selected based on the survey analysis. At least some of the groups/subsets of ions may be determined to exclude relatively intense ion species (e.g. excluding the top 5, or top 10 most intense ion species).

The above HDR methodology accumulated subsets of ions and performed a single MS1 analysis. Such a technique may be particularly applicable to relatively slow mass analysers, such as the orbital trapping mass analyser 110, where the analysis duration is of at least a similar duration to the time taken to accumulate all the ions prior to the HDR MS1 analysis (e.g. in excess of 100 ms). For relatively fast mass analysers, for example TOF mass analyser 150, that may obtain a mass spectrum in about 5 ms, it may be advantageous to perform multiple MS1 analyses as the ions are accumulated. For example, one or more subsets of ions may be accumulated in C-trap 100 and then sent for MS1 analysis at the TOF mass analyser 150. As such, for each ion scheduling cycle one or more subsets of ions accumulated in the ion trap may be analysed in the MS1 domain to generate a partial HDR mass spectrum. The full HDR mass spectrum may then be assembled from the accumulated plurality of partial mass spectrums covering different isolation windows. Advantageously, by splitting the full MS1 analysis into a plurality of partial MS1 analyses, subsets of ions for MS1 analysis may be scheduled by the method of ion scheduling which can be interleaved with other subsets of ions for e.g. MS2 analysis.

FIG. 7 shows an example method incorporating analyses for a HDR method of mass spectrometry. After several ion scheduling cycles for MS2 analyses relating to a DIA methodology, and several interleaved AGC MS1 analyses performed via a bypass (so as not to interrupt the pre-accumulation of ions for subsequent cycles), an ion scheduling cycle is dedicated to providing a series of subsets of ions for a HDR method. The subsets of ions each have a m/z range which may be determined based on an earlier survey analysis or AGC analysis. The m/z range for each subset of ions may be selected to exclude relatively intense regions of the m/z range of interest. Alternatively, where subsets of ions injections will include intense relatively intense ion species, said subset of ions may be skipped over or removed (via beam dump at an ion gate). Alternatively, a subset of ions having relatively intense species may be selectively attenuated by an attenuating ion gate through e.g. pulse width modulation. The precursor information from a MS1 analysis over the full m/z range of interest and the ion information from the narrower HDR MS1 analyses of the select subsets of ions may then be combined to make a full HDR mass spectrum, or an equivalently relevant list of precursor ions.

In some embodiments, the HDR method of mass spectrometry may be performed over a plurality of ion scheduling cycles. For example, where a survey analysis is not performed prior to the HDR method, this may be accounted for in the HDR methodology. Thus, in a first ion scheduling cycle, subsets of ions spanning the m/z range of interest may be accumulated in an ion trap (e.g. C-trap 100) and analysed in the MS1 domain to obtain an initial MS1 mass spectrum. In the first ion scheduling cycle, the ion scheduling device 50 may be operated using a relatively faster, lower resolution cycle to make a limited series of relatively quick MS1 analyses. These limited MS1 analyses may effectively act as a survey analysis. In a second ion scheduling cycle, the method of ion scheduling may output subsets of ions at a relatively higher resolution, the subsets of ions having targeted m/z ranges based on the MS1 information (ion species m/z and associated intensities) from the first ion scheduling cycle.

In some embodiments, the HDR method of mass spectrometry may be performed over a plurality of ion scheduling cycles, where for each of the plurality of ion scheduling cycles, a deviation of the ion scheduling device is varied such that the plurality groups of ions span a different m/z range or ion mobility range. It will be appreciated that some ion separation devices 50 separate ions into groups with some m/z dependent losses of ions at the fringes of each group. In some embodiments, the degree of the losses may be measured/calibrated, with the resulting mass spectra being corrected to account for them, although such techniques do not recover sensitivity. In some embodiments, by varying the m/z range of the groups for different ion scheduling cycles, the m/z range of the groups for e.g. a second ion scheduling cycle may span the relatively lossy fringes of the groups from a first ion scheduling cycle. FIG. 9 shown an example of such a methodology in which during a second ion scheduling cycle the ion scheduling device 50 is subject to a deviation such that the m/z range of the groups of the second ion scheduling cycle are centred on a m/z corresponding to the boundaries between the groups from the first ion scheduling cycle.

While the methodologies of FIGS. 7 and 9 show HDR methods in which the subsets of ions are acquired sequentially, it will be appreciated that in other embodiments the subsets of ions may be acquired at various times during a mass spectrometry workflow. As such, it may be more efficient to spread the acquisition of subsets of ions for a HDR analysis over a complete DIA or DDA methodology. This may allow the HDR analyses to be obtained at efficient points during the DIA/DDA workflow, for example during gaps in the ion scheduling device schedule where there are no DDA targets. In embodiments where AGC analyses are performed, and the accumulation of ions in the ion scheduling device 50 varied accordingly, the accumulation of subsets of ions as part of a HDR method may be assigned to best fit with the level of gain that the ion scheduling device 50 is set to for any ion scheduling single cycle.

In some ion scheduler device designs, it may not be possible to generate a complete MS1 spectrum during a single ion scheduling cycle, e.g. due to losses at fringes of the groups. In such embodiments, a mass spectrum spanning the m/z range of interest may be built up from multiple subsets of ions over a plurality of ion scheduling cycles. Building a MS1 spectrum over a plurality of ion scheduling cycles may also reduce or eliminate losses resulting from a relatively high amount of ions being accumulated in an ion scheduling device 50, as an ion capacity or dynamic range of a mass analyser may not allow a mass spectrum of all groups to be obtained simultaneously without losing low abundant signals, observing m/z or intensity dependent spectrum distortions, or having other side effects.

In some embodiments, the system may be operated more rapidly when there are fewer target windows, for example by adjusting voltage to skip over unmeasured areas or reduce resolving power. This may be advantageous when a few intense species are measured, which require lower amplification, lower ion accumulation time, and fewer target windows. If this is the case for the ion scheduling device 50, it may be beneficial to restrict the number of precursors in the high intensity group and potentially increase cycle time. Similarly, rules of resolving power, m/z separation between candidates may be toughened up for intense peaks, to allow faster operation.

Accordingly, the above description provides several embodiments of a method of scheduling ions which may be implemented on the mass spectrometry system 1 of FIG. 4. It will be appreciated that methods of ion scheduling according to this disclosure may be performed on other spectrometry systems, including ion mobility spectrometry systems. As such, the ions may be scheduled on the basis of their ion mobility and/or may be analysed on the basis of their ion mobility.

1. A method of scheduling ions for analysis, the method comprising:
performing a plurality of ion scheduling cycles, each ion scheduling cycle comprising:
an ion scheduling device receiving ions, wherein the ion scheduling device separates the ions into a plurality of groups according to their m/z or ion mobility and outputs the groups sequentially to an ion selection device; and
for each ion group received by the ion selection device, the ion selection device selects a subset of ions from the group and outputs the subset of ions for analysis,
wherein for each of the plurality of ion scheduling cycles, a deviation of the ion scheduling device is varied such that the plurality groups of ions span a different m/z range or ion mobility range, and
the ion selection device selects different subsets of ions from the plurality of groups of ions.

2. A method according to claim 1, wherein
for each group of ions, the ion selection device outputs a subset of ions having a m/z range or an ion mobility range which is centred about a central m/z or central ion mobility of the respective group of ions.

3. A method according to any claim 1, wherein
the ion scheduling device separates ions into a plurality of groups according to their m/z, each group having a first m/z window width; and
the ion selection device selects a subset of ions from each group having a second m/z window width, wherein the second m/z window width is less than the first m/z window width.

4. A method according to claim 3, wherein
the mass selector device outputs each subset of ions having different m/z ranges such that across the plurality of ion scheduling cycles the subsets of ions output cover a m/z range of interest.

5. A method according to claim 4, wherein
the first m/z window width is at least: 5 Th, 10 Th, 20 Th, 30 Th, or 50 Th Th; and/or
the second m/z window width is no greater than: 20 Th, 10 Th, 5 Th, or 2 Th.

6. A method according to claim 1, wherein
the ion scheduling device outputs the groups of ions to the ion selection device in order of increasing m/z or increasing ion mobility; or
the ion scheduling device outputs the groups of ions to the ion selection device in order of decreasing m/z or decreasing ion mobility.

7. A method according to claim 1, wherein
each of the plurality of groups output by the ion scheduling device are elongated along an axial direction of the ion scheduling device.

8. A method according to claim 1, wherein
the ion scheduling device comprises a linear ion guide; and
the ion scheduling device separates the ions into a plurality of groups of ions by application of a travelling wave potential along the linear ion guide.

9. A method according to claim 1, wherein
the ion scheduling device comprises a bypass region configured to allow ions to bypass the ion scheduling device to the ion selection device.

10. A method according to claim 9, further comprising
scheduling a survey group of ions for analysis during the plurality of ion scheduling cycles, wherein the survey group of ions is output to the ion selection device via the bypass region of the ion scheduling device.

11. A method according to claim 1, wherein
the ion scheduling device comprises:
a plurality of ion traps, wherein each ion trap is associated with a different m/z range or a different ion mobility range,
wherein the admission and/or extraction of ions from the plurality of ion traps is controlled in order to separate the ions into the plurality of groups according to their m/z or ion mobility.

12. A method of ion scheduling according to claim 1 provided as part of a Data Independent Acquisition (DIA) mass spectrometry method, the method further comprising
for each subset of ions:
fragmenting the ions to produce fragmented ions; and
mass analysing the fragmented ions.

13. A method according to claim 12, wherein
the fragmented ions are analysed by a TOF mass analyser at a frequency of at least 100 Hz.

14. A method of ion scheduling according to claim 1 provided as part of a Data Dependent Acquisition (DDA) mass spectrometry method, the method further comprising
obtaining a list of analytes of interest and associated m/z, wherein for each ion group received by the ion selection device, the ion selection device selects a subset of ions from the group of ions based on the list of analytes of interest and associated m/z.

15. A method of ion scheduling according to claim 1 provided as part of a High Dynamic Range (HDR) mass spectrometry method for a m/z range of interest, the method further comprising:
accumulating one or more subsets of ions output by the ion selection device in an ion trap; and
outputting the accumulated one or more subsets of ions from the ion trap to a mass analyser for mass analysis in the MS1 domain.

16. A method according to claim 15, further comprising
performing a survey analysis of the ions,
wherein the ions are separated into groups and/or the subsets of ions are selected based on the survey analysis.

17. A method according to claim 15, wherein
the method is performed over a plurality of ion scheduling cycles, wherein for each of the plurality of ion scheduling cycles, a deviation of the ion scheduling device is varied such that the plurality groups of ions span a different m/z range or ion mobility range.

18. A method according to claim 15, wherein
for each ion scheduling cycle the one or more subsets of ions accumulated in the ion trap are analysed in the MS1 domain to generate a partial HDR mass spectrum; and
a HDR mass spectrum is assembled from the plurality of partial mass spectrums.

19. A controller for a spectrometry system, the controller configured to cause the spectrometry system to perform a plurality of ion scheduling cycles to schedule ions for analysis, wherein for each ion scheduling cycle the controller is configured to:
cause an ion scheduling device of the spectrometry system to receive ions, wherein the ion scheduling device separates the ions into a plurality of groups according to their m/z or ion mobility and outputs the groups sequentially to an ion selection device of the spectrometry system; and
for each ion group received by the ion selection device, cause the ion selection device to select a subset of ions from the group and outputs the subset of ions for analysis,
wherein for each of the plurality of ion scheduling cycles, the controller causes the ion selection device to select different subsets of ions from the plurality of groups of ions.

20. A spectrometry system for analysing ions, the spectrometry system comprising:
an ion scheduling device;
an ion selection device; and
a controller according to claim 19,
wherein the ion scheduling device is configured to separate ions into a plurality of groups according to their m/z or ion mobility and to output the groups sequentially to the ion selection device; and
the ion selection device is configured to select a subset of ions from each group of ions received from the ion scheduling device and to output the subset of ions for analysis by the spectrometry system.
